(19) United States
(12) Patent Application Publication
(10) Pub. No.: US 2025/0271740 A1
(43) Pub. Date: Aug. 28, 2025

(54) LIGHT SOURCE APPARATUS AND PROJECTOR

(71) Applicant: SEIKO EPSON CORPORATION, Tokyo (JP)

(72) Inventor: Tomoharu MASUDA, Matsumoto-Shi (JP)

(21) Appl. No.: 19/058,513

(22) Filed: Feb. 20, 2025

(30) Foreign Application Priority Data
Feb. 22, 2024 (JP) 2024-025409

(51) Int. Cl. G03B 21/20

(52) U.S. Cl. CPC G03B 21/204; G03B 21/2013; G03B 21/2066

(57) ABSTRACT

A light source apparatus includes: multiple light emitters configured to emit first light having a first wavelength band; a wavelength converter containing a phosphor and configured to convert the first light into second light having a second wavelength band different from the first wavelength band and output the second light; and an angle converting member configured to convert an angular distribution of the second light output from the wavelength converter. The wavelength converter has a first surface which faces one side in a longitudinal direction and via which the second light exits toward the angle converting member, a second surface facing a side opposite the first surface, and a third surface which intersects with both the first and second surfaces and on which the first light is incident, and a density of fluorescence emission points of the phosphor decreases along a direction from the second surface toward the first surface.

The present application is based on, and claims priority from JP Application Serial Number 2024-025409, filed Feb. 22, 2024, the disclosure of which is hereby incorporated by reference herein in its entirety.

### BACKGROUND

### 1. Technical Field

The present disclosure relates to a light source apparatus and a projector.

### 2. Related Art

As a light source apparatus used in a projector, there has been a proposed light source apparatus that outputs fluorescence emitted from a phosphor when the phosphor is irradiated with excitation light emitted from a light emitter. JP-A-2023-108325 discloses a light source apparatus including a light source element that outputs excitation light and a wavelength converting member containing a phosphor that converts the excitation light into fluorescence.

JP-A-2023-108325 is an example of the related art.

In the technology described in JP-A-2023-108325, the density of fluorescence emission points of the phosphor contained in the wavelength converting member is uniform across the entire wavelength converting member. Since the fluorescence emitted at each location in the wavelength converting member is collected at the light exiting surface of the wavelength converting apparatus and then exits out of the wavelength converting apparatus, the phosphor in a portion closer to the light exiting surface absorbs a larger amount of the fluorescence. Therefore, when the temperature of a portion of the wavelength converting member that is close to the light exiting surface becomes too high, there is a concern about an increase in the amount of thermal quenching of the fluorescence in the portion of the wavelength converting member that is close to the light exiting surface. There is therefore a concern about a decrease in the wavelength conversion efficiency, which is the efficiency at which the wavelength converting member converts the excitation light into the fluorescence.

### SUMMARY

A light source apparatus according to an aspect of the present disclosure includes: multiple light emitters configured to emit first light having a first wavelength band; a wavelength converter containing a phosphor and configured to convert the first light into second light having a second wavelength band different from the first wavelength band and output the second light; and an angle converting member configured to convert an angular distribution of the second light output from the wavelength converter. The wavelength converter has a first surface which faces one side in a longitudinal direction and via which the second light exits toward the angle converting member, a second surface facing a side opposite the first surface, and a third surface which intersects with both the first and second surfaces and on which the first light is incident, and a density of fluorescence emission points of the phosphor decreases along a direction from the second surface toward the first surface.

A projector according to another aspect of the present disclosure includes: the light source apparatus described above; a light modulator configured to modulate light containing the second light output from the light source apparatus; and a projection optical apparatus configured to project the light modulated by the light modulator.

### BRIEF DESCRIPTION OF THE DRAWINGS

FIG. 1 is a schematic configuration diagram of a projector according to a first embodiment.

FIG. 2 is a schematic configuration diagram of a first Illuminator in the first embodiment.

FIG. 3 shows the distribution of the density of fluorescence emission points of a wavelength converter in the longitudinal direction and the distribution of the intensity of first light in the first embodiment.

FIG. 4 is a schematic configuration diagram of a first Illuminator in a variation of the first embodiment.

FIG. 5 is a schematic configuration diagram of a first Illuminator in a second embodiment.

FIG. 6 is a schematic configuration diagram of a first Illuminator according to a third embodiment.

### DESCRIPTION OF EMBODIMENTS

Embodiments of the present disclosure will be described with reference to the drawings. In the drawings to which the following description refers, each layer or each member may be shown at a different scale for clarity of the layer or the member.

The following description with reference to the drawings will be made by using an XYZ orthogonal coordinate systemin as required. The Z-axis is an axis along the vertical direction of a projector. The X-axis is an axis parallel to a first optical axis J1, which is the optical axis of a first Illuminator. The Y-axis is an axis perpendicular to both the X-axis and the Z-axis.

### First Embodiment

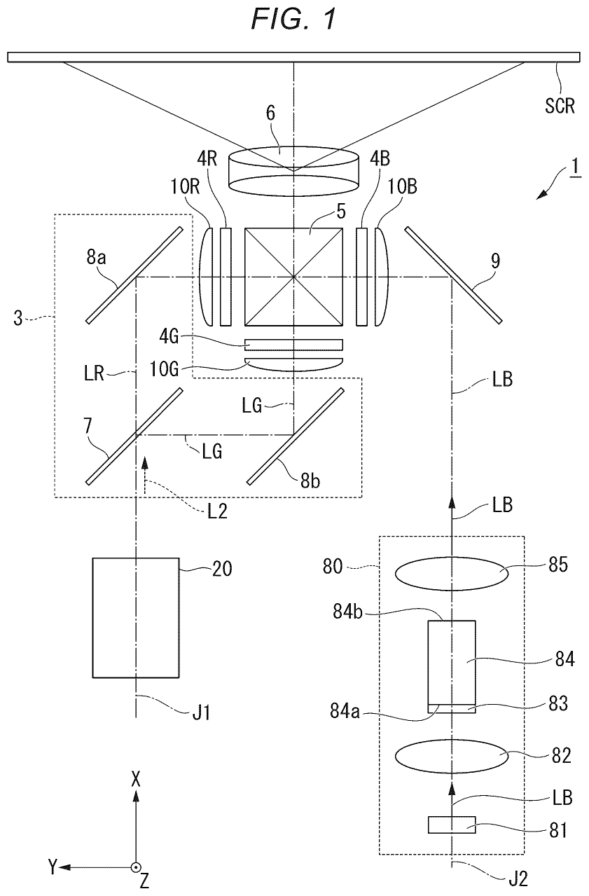

A first embodiment of the present disclosure will be described below with reference to the drawings. FIG. 1 is a schematic configuration diagram of a projector 1 according to the present embodiment. The projector 1 according to the present embodiment is an example of a projector using liquid crystal panels as light modulators. The projector 1 is a projection-type image display apparatus that displays a color image on a screen SCR, which is a projection receiving surface, as shown in FIG. 1. The projector 1 includes three light modulators 4R, 4G, and 4B corresponding to three types of color light, red light LR, green light LG, and blue light LB. The projector 1 includes a first illuminator 20, a second illuminator 80, a color separation system 3, the light modulators 4R, 4G, and 4B, a light combiner 5, and a projection optical apparatus 6.

The first Illuminator 20 outputs yellow second light L2 toward the color separation system 3. The second Illuminator 80 outputs the blue light LB toward the light modulator 4B. Detailed configurations of the first Illuminator 20 and the second Illuminator 80 will be described later.

The color separation system 3 separates the yellow second light L2 output from the first Illuminator 20 into the red light LR and the green light LG. The color separation system 3 includes a dichroic mirror 7, a first reflection mirror 8a, and a second reflection mirror 8b.

The dichroic mirror 7 separates the second light L2 into the red light LR and the green light LG. The dichroic mirror 7 transmits the red light LR and reflects the green light LG. The second reflection mirror 8b is disposed in the optical path of the green light LG. The second reflection mirror 8b reflects the green light LG, which has been reflected off the dichroic mirror 7, toward the light modulator 4G. The first reflection mirror 8a is disposed in the optical path of the red light LR. The first reflection mirror 8a reflects the red light LR, which has passed through the dichroic mirror 7, toward the light modulator 4R.

The blue light LB output from the second Illuminator 80 is reflected off a reflection mirror 9 toward the light modulator 4B. The second illuminator 80 includes a second light source section 81, a light collecting lens 82, a diffuser plate 83, a rod lens 84, and a relay lens 85. The second light source section 81 is configured with at least one semiconductor laser. The second light source section 81 outputs the blue light LB, which is laser light, toward the light collecting lens 82. Note that the second light source section 81 is not limited to a semiconductor laser and may be configured with a light emitting diode (LED) that emits blue light.

The light collecting lens 82 is configured with a convex lens. The light collecting lens 82 causes the blue light LB output from the second light source section 81 to enter the diffuser plate 83 with the blue light LB collected at the diffuser plate 83. The diffuser plate 83 diffuses the blue light LB output from the light collecting lens 82 with a predetermined diffusion degree to generate blue light LB having a uniform light orientation distribution. The diffuser plate 83 is configured, for example, with a ground glass made of optical glass.

The blue light LB diffused by the diffuser plate 83 enters the rod lens 84. The rod lens 84 has a prismatic shape extending along a second optical axis J2. The rod lens 84 has a light incident end surface 84a provided at one end and a light exiting end surface 84b provided at the other end. The diffuser plate 83 is fixed to the light incident end surface 84a of the rod lens 84 with an optical adhesive (not shown). It is desirable that the refractive index of the diffuser plate 83 is as close as possible to the refractive index of the rod lens 84. Note that the second optical axis J2 is the center axis of the blue light LB output from the second illuminator 80.

The blue light LB propagates through the interior of the rod lens 84 while being totally reflected therein and exits via the light exiting end surface 84b with the uniformity of the illuminance distribution of the blue light LB enhanced. The blue light LB output from the rod lens 84 enters the relay lens 85. The relay lens 85 causes the blue light LB with the uniformity of the illuminance distribution enhanced by the rod lens 84 to be incident on the reflection mirror 9.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB. The light modulators 4R, 4G, and 4B can each, for example, be a transmissive liquid crystal panel. Polarizer plates that are not shown are disposed on the light incident side and the light exiting side of each of the light modulators 4R, 4G, and 4B. The polarizer plates each transmit only linearly polarized light polarized in a specific direction. The red light LR and the green light LG are two types of light into which the second light L2 is separated by the dichroic mirror 7, as described above. The light modulators 4R, 4G, and 4B therefore modulate light containing the second light L2.

A field lens 10R is disposed on the light incident side of the light modulator 4R. The field lens 10R parallelizes the chief ray of the red light LR to be incident on the light modulator 4R. A field lens 10G is disposed on the light incident side of the light modulator 4G. The field lens 10G parallelizes the chief ray of the green light LG to be incident on the light modulator 4G. A field lens 10B is disposed on the light incident side of the light modulator 4B. The field lens 10B parallelizes the chief ray of the blue light LB to be incident on the light modulator 4B.

The light combiner 5 combines the three types of image light, which are the result of the modulation performed by the light modulators 4R, 4G, and 4B, with one another, and outputs the combined image light toward the projection optical apparatus 6. The light combiner 5 can, for example, be a cross dichroic prism.

The projection optical apparatus 6 is configured with multiple projection lenses that are not shown. The projection optical apparatus 6 enlarges the combined image light from the light combiner 5 and projects the enlarged image light toward the screen SCR. The projection optical apparatus 6 projects the image light LR, the image light LG, and the image light LB modulated by the light modulators 4R, 4G, and 4B, respectively. A color image is thus displayed on the screen SCR.

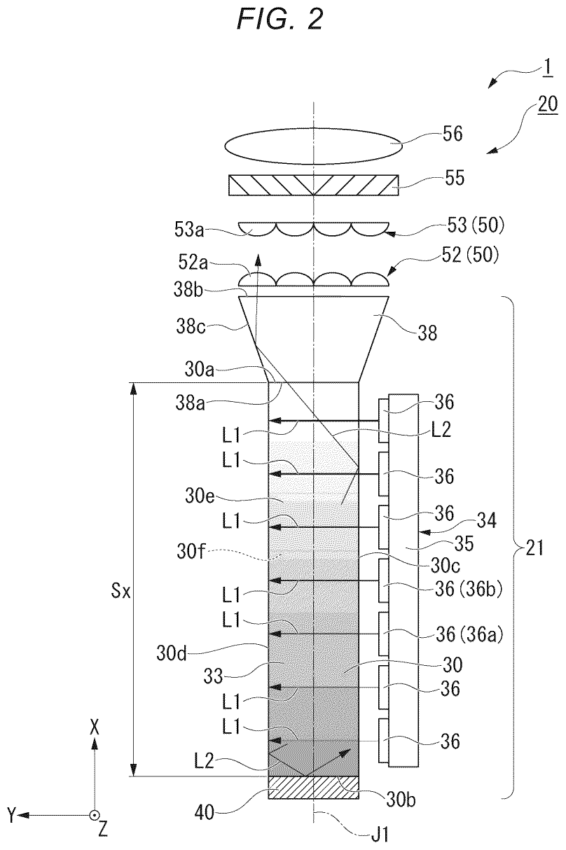

FIG. 2 is a schematic configuration diagram of the first Illuminator 20 in the present embodiment. The first illuminator 20 includes a light source apparatus 21, an optical integration system 50, a polarization converter 55, and a superimposing system 56, as shown in FIG. 2.

The light source apparatus 21 converts first light L1 into the yellow second light L2, and outputs the second light L2 toward the optical integration system 50. The light source apparatus 21 includes a wavelength converter 30, a light source section 34, an angle converting member 38, and a reflector section 40.

The wavelength converter 30 has a quadrangular prismatic shape extending in the X-axis direction. The dimension of the wavelength converter 30 in the X-axis direction is greater than each of the dimensions thereof in the Y-axis and Z-axis directions. In the present embodiment, the X-axis direction is the longitudinal direction of the wavelength converter 30. In the following description, the X-axis direction is referred to as the longitudinal direction in some cases. The longitudinal direction is parallel to the direction in which the first optical axis J1 extends. The longitudinal direction is the direction in which the wavelength converter 30 outputs the second light L2. The dimension of the wavelength converter 30 in the Y-axis direction and the dimension of the wavelength converter 30 in the Z-axis direction are substantially equal to each other. The wavelength converter 30 therefore has a substantially square cross-sectional shape when taken along a plane perpendicular to the longitudinal direction. The wavelength converter 30 may have another cross-sectional shape such as a rectangular cross-sectional shape when taken along a plane perpendicular to the longitudinal direction. In the following description, the Y-axis direction is referred to as a light incident direction in some cases. The light incident direction is the direction in which the first light L1 enters the wavelength converter 30.

The wavelength converter 30 has six surfaces. The wavelength converter 30 has a first surface 30a, which faces one side in the longitudinal direction (X-axis direction), and a second surface 30b, which faces the other side in the longitudinal direction (X-axis direction), the two surfaces located on opposite sides in the longitudinal direction. The second surface 30b is disposed away from the first surface 30a in the longitudinal direction. The second surface 30b faces the side opposite the first surface 30a. A dimension Sx of the wavelength converter 30 in the longitudinal direction is the distance between the first surface 30a and the second surface 30b.

The wavelength converter 30 has a third surface 30c, which faces one side in the light incident direction (Y-axis direction), and a fourth surface 30d, which faces the other side in the light incident direction (Y-axis direction), the two surfaces located on opposite sides in the light incident direction. The fourth surface 30d is disposed away from the third surface 30c in the light incident direction. The fourth surface 30d faces the side opposite the third surface 30c. The third surface 30c and the fourth surface 30d each intersect with both the first surface 30a and the second surface 30b. In the present embodiment, the third surface 30c and the fourth surface 30d are each perpendicular to both the first surface 30a and the second surface 30b.

The wavelength converter 30 has a fifth surface 30e, which faces one side in Z-axis direction, and a sixth surface 30f, which faces the other side in the Z-axis direction, the two surfaces located on opposite sides in the Z-axis direction. In the following description, the third surface 30c, the fourth surface 30d, the fifth surface 30e, and the sixth surface 30f may each be referred to as a “side surface”.

The wavelength converter 30 converts the first light L1 having a first wavelength band into the second light L2 having a second wavelength band different from the first wavelength band. The wavelength converter 30 outputs the second light L2 toward the angle converting member 38. The first light L1 is output from the light source section 34 in the light incident direction (Y-axis direction), and enters the wavelength converter 30 via the third surface 30c. The second light L2 is guided through the interior of the wavelength converter 30 and is then output via the first surface 30a toward the angle converting member 38. That is, the first surface 30a causes the second light L2 to exit toward the angle converting member 38.

The wavelength converter 30 contains a phosphor 33. The phosphor 33 converts the first light L1 into the second light L2. In the present embodiment, the wavelength converter 30 is made, for example, of fluorescent glass that is glass in which rare earth ions are dispersed, a ceramic phosphor made of a single crystal phosphor or a polycrystalline phosphor, or a material in which the phosphor 33 is dispersed in a binder such as a resin. The fluorescent glass may, for example, be LUMILASS (product name, manufactured by Sumita Optical Glass, Inc.). The phosphor 33 contains, for example, a YAG-based phosphor (any of Ce:YAG, Pr:YAG, Eu:YAG, and Cr:YAG) made of (Y_{1-x-y}, Gdₓ, Lu_{y})₃(Al, Ga)₅O₁₂ in which any of Ce, Pr, Eu, and Cr is dispersed as an activator. The activator absorbs the first light L1 and outputs the second light L2, which is yellow fluorescence. The activator may contain one element selected from Ce, Pr, Eu, and Cr, or may contain multiple elements selected from Ce, Pr, Eu, and Cr. The wavelength converter 30 is made of a material in which a large number of phosphor particles are dispersed in a binder. In the following description, the activator contained in the phosphor 33 is referred to as fluorescent emission points in some cases. In the following description, the ratio (atomic percent, at %) of the activator atoms to the wavelength converter 30 is referred to as a density Dp of the fluorescence emission points. The density Dp of the fluorescence emission points of the wavelength converter 30 will be described later in detail.

In the wavelength converter 30 in the present embodiment, the density Dp of the fluorescence emission points in the longitudinal direction (X-axis direction) continuously changes, as will be described later. To this end, the wavelength converter 30 is desirably formed by a Czochralski method (CZ method). The density Dp of the fluorescence emission points in the longitudinal direction can thus be smoothly changed. Note that the wavelength converter 30 may instead be formed by a floating zone method (FZ method).

When the first light L1 enters the wavelength converter 30, the phosphor 33 absorbs the first light L1 and outputs the second light L2 having the second wavelength band. The wavelength converter 30 thus converts the first light L1 into the second light L2. In the present embodiment, the second light L2 is yellow fluorescence containing a red light component and a green light component. The second wavelength band, to which the second light L2 belongs, is, for example, a wavelength band of yellow light having wavelengths ranging from 490 nm to 750 nm. When the phosphor 33 absorbs the first light L1, the phosphor 33 generates heat. Part of the second light L2 guided through the interior the wavelength converter 30 is absorbed by the phosphor 33. When the phosphor 33 absorbs the second light L2, the phosphor 33 generates heat.

The light source section 34 outputs the first light L1 toward the wavelength converter 30. The light source section 34 is disposed so as to face the third surface 30c of the wavelength converter 30 in the light incident direction (Y-axis direction). The light source section 34 includes a substrate 35 and a light emitter 36. That is, the light source apparatus 21 includes the light emitter 36. The light source section 34 may further include other optical members such as a light guide plate, a diffuser plate, and a lens.

The substrate 35 supports the light emitter 36. The light emitter 36 is provided at one of the outer surfaces of the substrate 35 that faces the third surface 30c of the wavelength converter 30 in the light incident direction. The light emitter 36 is configured, for example, with a light emitting diode. The light emitter 36 emits the first light L1 having the first wavelength band toward the third surface 30c of the wavelength converter 30. The first light L1 is thus incident on the third surface 30c. The first light L1 enters the wavelength converter 30 via the third surface 30c. In the present embodiment, the first wavelength band has, for example, a wavelength range from 400 nm to 480 nm corresponding to a color range from blue to purple. The peak wavelength of the first light L1 is, for example, 445 nm. The light source section 34 includes multiple light emitters 36. That is, the light source apparatus 21 includes the multiple light emitter 36. In the present embodiment, the light source section 34 includes seven light emitters 36. The light emitters 36 are arranged side by side in the longitudinal direction (X-axis direction). The light emitters 36 each face the third surface 30c in the light incident direction (Y-axis direction). The number of the light emitters 36 provided in the light source section 34 is not limited to a specific number, and may be six or less or eight or more. The multiple light emitters 36 include a first light emitter 36a and a second light emitter 36b.

The first light emitter 36a is any one of the multiple light emitters 36. The second light emitter 36b is any one of the multiple light emitters 36 that is disposed closer to the first surface 30a of the wavelength converter 30 than the first light emitter 36a. In the present embodiment, an intensity P1 of the first light L1 emitted by the second light emitter 36b is higher than the intensity P1 of the first light L1 emitted by the first light emitter 36a. Therefore, in the present embodiment, a light emitter 36 disposed closer to the first surface 30a emits more intense first light L1. The intensity P1 of the first light L1 emitted to the third surface 30c thus increases along the direction from the second surface 30b toward the first surface 30a. The intensity P1 of the first light L1 incident on the third surface 30c therefore increases along the direction from the second surface 30b toward the first surface 30a. The intensity P1 of the first light L1 that enters the wavelength converter 30 via the third surface 30c thus increases along the direction from the second surface 30b toward the first surface 30a.

The reflector section 40 is provided at the second surface 30b of the wavelength converter 30, as shown in FIG. 2. That is, the reflector section 40 is provided at the second surface 30b. The reflector section 40 reflects the second light L2 having been guided through the interior of the wavelength converter 30 and having reached the second surface 30b. The reflector section 40 is configured with a metal film or a dielectric multilayer film formed at the second surface 30b.

The first light L1 emitted from each of the light emitters 36 toward the third surface 30c enters the wavelength converter 30 via the third surface 30c. When the first light L1 enters the wavelength converter 30, the phosphor 33 is excited by the first light L1, so that the second light L2 is emitted at the fluorescence emission points. The second light L2 is emitted radially from each of the fluorescence emission points, the fluorescence emission points being as the center. The second light L2 traveling toward the four side surfaces 30c, 30d, 30e, and 30f of the wavelength converter 30 travels toward the first surface 30a or the second surface 30b while repeatedly totally reflected off the side surfaces 30c, 30d, 30e, and 30f. The second light L2 traveling toward the second surface 30b is reflected off the reflector section 40 and travels toward the first surface 30a. The second light L2 emitted at the fluorescence emission points thus travels toward the first surface 30a, passes through the first surface 30a, and enters the angle converting member 38. Therefore, in the wavelength converter 30 in the present embodiment, an intensity P2 of the second light L2 increases along the direction from the second surface 30b toward the first surface 30a.

The angle converting member 38 is provided on the light exiting side of the first surface 30a of the wavelength converter 30. The second light L2 having exited via the first surface 30a enters the angle converting member 38. The angle converting member 38 is configured, for example, with a light transmissive member such as a tapered rod. The angle converting member 38 has a light incident surface 38a, on which the second light L2 output from the wavelength converter 30 is incident, a light exiting surface 38b, via which the second light L2 exits, and a reflection side surface 38c, which reflects the second light L2 toward the light exiting surface 38b. The light incident surface 38a faces the first 30a surface in the longitudinal direction (X-axis direction).

The angle converting member 38 has a truncated quadrangular pyramidal shape, and has a cross section perpendicular to the first optical axis J1 and having a cross-sectional area that increases along the traveling direction of the second light L2. The area of the light exiting surface 38b is therefore greater than the area of the light incident surface 38a. Note in the present embodiment that the optical axis of the angle converting member 38 coincides with the first optical axis J1. The optical axis of the angle converting member 38 does not need to coincide with the first optical axis J1.

The traveling direction of the second light L2 having entered the angle converting member 38 is changed so as to approach the direction parallel to the first optical axis J1 whenever the second light L2 is reflected off the reflection side surface 38c. The angle converting member 38 thus changes the angular distribution of the second light L2 output from the wavelength converter 30. In general, since the etendue of light specified by the product of the area of a light exiting region and the solid angle (largest exiting angle) of the light is preserved, the etendue of the second light L2 is preserved before and after the second light L2 passes through the angle converting member 38. The area of the light exiting surface 38b is greater than the area of the light incident surface 38a, as described above. The largest exiting angle of the second light L2 exiting via the light exiting surface 38b is therefore smaller than the largest incident angle of the second light L2 incident on the light incident surface 38a in view of etendue preservation.

In the present embodiment, the light incident surface 38a of the angle converting member 38 is fixed to the first surface 30a of the wavelength converter 30 via an optical adhesive that is not shown. The angle converting member 38 and the wavelength converter 30 are therefore in contact with each other via the optical adhesive, so that no air gap is provided between the angle converting member 38 and the wavelength converter 30. When an air gap is provided between the angle converting member 38 and the wavelength converter 30, the second light L2 incident on the light incident surface 38a of the angle converting member 38 at angles greater than or equal to the critical angle out of the second light L2 having reached the light incident surface 38a is totally reflected off the light incident surface 38a and cannot therefore enter the angle converting member 38. In contrast, when no air gap is provided between the angle converting member 38 and the wavelength converter 30 as in the present embodiment, the amount of the second light L2 that cannot enter the angle converting member 38 can be reduced. It is desirable that the refractive index of the angle converting member 38 is as close as possible to the refractive index of the wavelength converter 30.

Note that the angle converting member 38 is not necessarily configured as in the present embodiment, and may, for example, be a compound parabolic concentrator (CPC). Even when a CPC is used as the angle converting member 38, the same advantages as those provided when the tapered rod described above is used can be provided. Furthermore, the light source apparatus 21 may not necessarily include the angle converting member 38.

The optical integration system 50 includes a first lens array 52 and a second lens array 53. The optical integration system 50 and the superimposing system 56 constitute a uniform illumination system that homogenizes the distribution of the intensity P2 of the second light L2 output from the light source apparatus 21 in each of the light modulators 4R and 4G, which are each an illumination receiving region. The second light L2 output via the light exiting surface 38b of the angle converting member 38 enters the first lens array 52.

The first lens array 52 includes multiple first lenslets 52a. The first lenslets 52a divide the second light L2 output from the angle converting member 38 into multiple sub-luminous fluxes. The first lenslets 52a are arranged in a matrix in a plane perpendicular to the first optical axis J1. The first lenslets 52a each have a shape substantially similar to the shape of an image formation region of each of the light modulators 4R and 4G. The sub-luminous fluxes output from the first lens array 52 are thus each efficiently incident on the image formation region of each of the light modulators 4R and 4G.

The second lens array 53 is disposed on the light exiting side of the first lens array 52. The second light L2 output from the first lens array 52 enters the second lens array 53. The second lens array 53 includes multiple second lenslets 53a corresponding to the multiple first lenslets 52a. The second lens array 53 along with the superimposing system 56 brings the sub-luminous fluxes output from the first lenslets 52a into focus in the vicinity of the image formation region of each of the light modulators 4R and 4G.

The polarization converter 55 converts the polarization directions of the second light L2 output from the second lens array 53. In more detail, the polarization converter 55 converts each of the sub-luminous fluxes, into which the second light L2 has been divided by the first lens array 52 and which have been output from the second lens array 53, into linearly polarized light. The second light L2 output from the second lens array 53 enters the superimposing system 56. The superimposing system 56 causes the second light L2 to enter the color separation system 3.

The density Dp of the fluorescence emission points of the wavelength converter 30 will next be described. Note in the following description that the amount of the first light L1 absorbed by the phosphor 33 is simply referred to as “the amount of the absorbed first light L1” in some cases. The amount of the absorbed first light L1 correlates with both the intensity P1 of the first light L1 and the density Dp of the fluorescence emitting points. The amount of the absorbed first light L1 increases as the intensity P1 of the first light L1 increases. The amount of the absorbed first light L1 decreases as the density Dp of the fluorescence emission points decreases. When the phosphor 33 absorbs the first light L1, the phosphor 33 generates heat, as described above. Therefore, as the amount of the absorbed first light L1 increases, the amount of the heat generated by the phosphor 33 increases.

Part of the second light L2 guided through the interior the wavelength converter 30 is absorbed by the phosphor 33, as described above. In the following description, the amount of the second light L2 absorbed by the phosphor 33 is simply referred to as “the amount of the absorbed second light L2” in some cases. The amount of the absorbed second light L2 correlates with both the intensity P2 of the second light L2 and the density Dp of the fluorescence emission points. The amount of the absorbed second light L2 increases as the intensity P2 of the second light L2 increases. The amount of the absorbed second light L2 decreases as the density Dp of the fluorescence emission points decreases. When the phosphor 33 absorbs the second light L2, the phosphor 33 generates heat. Therefore, as the amount of the absorbed second light L2 increases, the amount of the heat generated in the phosphor 33 increases.

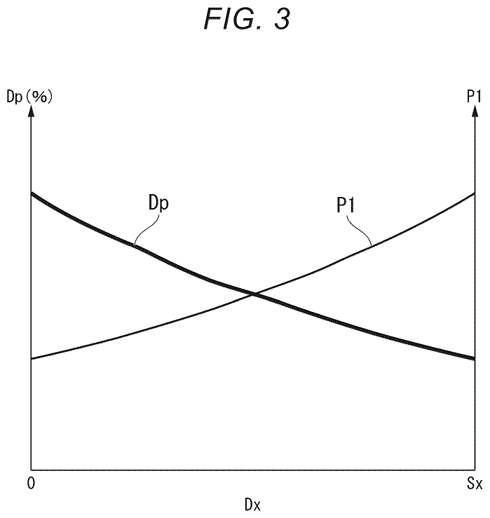

FIG. 3 shows the distribution of the density Dp of the fluorescence emission points of the wavelength converter 30 in the longitudinal direction (X-axis direction) and the distribution of the intensity P1 of the first light L1 in the present embodiment. The horizontal axis in FIG. 3 represents a distance Dx from the second surface 30b in the longitudinal direction. The origin of the horizontal axis in FIG. 3 is the position of the second surface 30b in the longitudinal direction. The dimension Sx of the wavelength converter 30 in the longitudinal direction is the distance between the first surface 30a and the second surface 30b, as described above. The first surface 30a is located at Sx on the horizontal axis in FIG. 3. The first vertical axis in FIG. 3 represents the density Dp of the fluorescent light emission points. The second vertical axis in FIG. 3 represents the intensity P1 of the first light L1. The intensity P1 of the first light L1 shown in FIG. 3 is the intensity of the first light L1 incident on the third surface 30c.

In the present embodiment, the second light L2 emitted at the fluorescence emission points travels toward the first surface 30a, passes through the first surface 30a, and enters the angle converting member 38, as described above. The intensity P2 of the second light L2 in the wavelength converter 30 therefore increases along the direction from the second surface 30b toward the first surface 30a. The amount of the second light L2 absorbed by the phosphor 33 increases as the intensity P2 of the second light L2 increases, as described above. Furthermore, the amount of the heat generated by the phosphor 33 increases as the amount of the absorbed second light L2 increases, as described above. Therefore, when the density Dp of the fluorescence emission points is uniform in the longitudinal direction (X-axis direction), the amount of the absorbed second light L2 increases along the direction from the second surface 30b toward the first surface 30a, so that the amount of the heat generated by the phosphor 33 increases along the direction from the second surface 30b toward the first surface 30a. Therefore, when the density Dp of the fluorescence emission points is uniform in the longitudinal direction, the portion of the wavelength converter 30 that is closer to the first surface 30a has a higher temperature. When the temperature of the portion of the wavelength converter 30 that is close to the first surface 30a becomes too high, the thermal quenching of the second light L2 in the portion of the wavelength converter 30 that is close to the first surface 30a is likely to increase. Therefore, when the density Dp of the fluorescence emission points is uniform in the longitudinal direction, there is a concern about a decrease in the wavelength conversion efficiency, which is the efficiency at which the wavelength converter 30 converts the first light L1 into the second light L2. In the following description, a portion of the wavelength converter 30 that is close to the first surface 30a is simply referred to as a “portion close to the first surface 30a” in some cases. Furthermore, in the following description, a portion of the wavelength converter 30 that is close to the second surface 30b is simply referred to as a “portion close to the second surface 30b” in some cases.

In contrast, in the present embodiment, the density Dp of the fluorescence emission points of the phosphor 33 in the longitudinal direction (X-axis direction) decreases along the direction from the second surface 30b toward the first surface 30a, as shown in FIG. 3. In more detail, the density Dp of the fluorescence emission points continuously decreases along the direction from the second surface 30b toward the first surface 30a. In the present embodiment, the density Dp of the fluorescence emission points decreases in a substantially linear manner along the direction from the second surface 30b toward the first surface 30a. Therefore, in the embodiment, an increase in the amount of the second light L2 absorbed in the portion close to the first surface 30a can be suppressed. Note that the density Dp of the fluorescence emission points may decrease in the form of a curve along the direction from the second surface 30b toward the first surface 30a.

In the present embodiment, the intensity P1 of the first light L1 incident on the third surface 30c therefore increases along the direction from the second surface 30b toward the first surface 30a, as shown in FIG. 3. The intensity P1 of the first light L1 that enters the portion close to the second surface 30b can therefore be reduced. Therefore, in the present embodiment, the amount of the first light L1 absorbed in the portion close to the second surface 30b can be reduced irrespective of the high density Dp of the fluorescence emission points at the second surface 30b. The situation in which the temperature of the portion close to the second surface 30b becomes too high can thus be avoided, so that the amount of thermal quenching of the second light L2 in the portion of the wavelength converter 30 that is close to the second surface 30b can be suppressed.

According to the present embodiment, the light source apparatus 21 includes the multiple light emitters 36, which emit the first light L1 having the first wavelength band, the wavelength converter 30, which contains the phosphor 33, converts the first light L1 into the second light L2 having the second wavelength band different from the first wavelength band, and outputs the second light L2, and the angle converting member 38, which converts the angular distribution of the second light L2 output from the wavelength converter 30. The wavelength converter 30 has the first surface 30a, which faces one side in the longitudinal direction (X-axis direction) and via which the second light L2 exits toward the angle converting member 38, the second surface 30b, which faces the side opposite the first surface 30a, and the third surface 30c, which intersects with both the first surface 30a and the second surface 30b and on which the first light L1 is incident, and the density Dp of the fluorescence emission points of the phosphor 33 decreases along the direction from the second surface 30b toward the first surface 30a. In the present embodiment, the second light L2 emitted at the fluorescence emission points passes through the first surface 30a, and enters the angle converting member 38, as described above. The intensity P2 of the second light L2 guided through the interior of the wavelength converter 30 therefore increases along the direction from the second surface 30b toward the first surface 30a. Therefore, when the density Dp of the fluorescence emission points is uniform in the longitudinal direction, the amount of the absorbed second light L2 increases along the direction from the second surface 30b toward the first surface 30a, as described above. That is, the amount of the second light L2 absorbed in the portion close to the first surface 30a increases. In contrast, the present embodiment, in which the density Dp of the fluorescence emission points of the phosphor 33 decreases along the direction from the second surface 30b toward the first surface 30a, can suppress an increase in the amount of the second light L2 absorbed in the portion of the wavelength converter 30 that is close to the first surface 30a. The amount of the second light L2 that exits via the first surface 30a can therefore be increased, so that the wavelength conversion efficiency of the wavelength converter 30 can be increased.

In the present embodiment, an increase in the amount of the second light L2 absorbed in the portion of the wavelength converter 30 that is close to the first surface 30a can be suppressed, so that the amount of the heat generated by the phosphor 33 in the portion close to the first surface 30a can be suppressed, as described above. The situation in which the temperature of the portion close to the first surface 30a becomes too high can thus be avoided. The thermal quenching of the second light L2 in the portion close to the first surface 30a can therefore be reduced, so that the wavelength conversion efficiency of the wavelength converter 30 can be more preferably increased.

Furthermore, the present embodiment, in which the density Dp of the fluorescence emission points of the phosphor 33 decreases along the direction from the second surface 30b toward the first surface 30a, can suppress the amount of the first light L1 absorbed in the portion of the wavelength converter 30 that is close to the first surface 30a, as described above. The amount of the heat generated by the phosphor 33 in the portion close to the first surface 30a can thus be more preferably suppressed. The situation in which the temperature of the portion close to the first surface 30a becomes too high can thus be more preferably avoided, so that the amount of thermal quenching of the second light L2 in the portion close to the first surface 30a can be more preferably suppressed. The wavelength conversion efficiency of the wavelength converter 30 can therefore be more preferably increased.

According to the present embodiment, the multiple light emitters 36 each face the third surface 30c and are disposed side by side in the longitudinal direction (X-axis direction), and include the first light emitter 36a and the second light emitter 36b, which is disposed closer to the first surface 30a than the first light emitter 36a, and the intensity P1 of the first light L1 emitted by the second light emitter 36b is higher than the intensity P1 of the first light L1 emitted by the first light emitter 36a. In the present embodiment, the density Dp of the fluorescence emission points of the phosphor 33 decreases along the direction from the second surface 30b toward the first surface 30a, so that the portion of the wavelength converter 30 that is close to the second surface 30b has a high density Dp of the fluorescence emission points, as described above. Therefore, when the intensities P1 of the first light L1 emitted by the light emitters 36 are equal to each other, the amount of the first light L1 absorbed by the phosphor 33 in the portion close to the second surface 30b increases. The amount of the heat generated by the phosphor 33 in the portion close to the second surface 30b thus increases, so that the temperature of the portion close to the second surface 30b is likely to increase. The amount of thermal quenching of the second light L2 in the portion close to the second surface 30b therefore likely to increase. In contrast, in the present embodiment, the intensity P1 of the first light L1 that enters the portion of the wavelength converter 30 that is close to the second surface 30b can be reduced. The amount of the first light L1 absorbed in the portion close to the second surface 30b can thus be reduced, so that the situation in which the temperature of the portion close to the second surface 30b becomes too high can be avoided. The amount of thermal quenching of the second light L2 in the portion of the wavelength converter 30 that is close to the second surface 30b can therefore be suppressed. The wavelength conversion efficiency of the wavelength converter 30 can therefore be more preferably increased.

In the present embodiment, since the density Dp of the fluorescence emission points in the portion of the wavelength converter 30 that is close to the first surface 30a is low as described above, it is difficult to increase the amount of the second light L2 emitted in the portion close to the first surface 30a. In the present embodiment, however, the intensity P1 of the first light L1 that enters the portion close to the first surface 30a can be increased. The amount of the second light L2 emitted in the portion of the wavelength converter 30 that is close to the first surface 30a can thus be increased. The wavelength conversion efficiency of the wavelength converter 30 can therefore be more preferably increased.

According to the present embodiment, the reflector section 40, which reflects the second light L2, is provided at the second surface 30b. Therefore, out of the second light L2 emitted at the fluorescence emission points, the second light L2 traveling toward the second surface 30b can be reflected off the reflector section 40 toward the first surface 30a. Leakage of the second light L2 out of the wavelength converter 30 via the second surface 30b can thus be suppressed, so that the amount of the second light L2 that exits via the first surface 30a can be more preferably increased. The wavelength conversion efficiency of the wavelength converter 30 can therefore be more preferably increased.

According to the present embodiment, the projector 1 includes the light source apparatus 21, the light modulators 4R, 4G, and 4B, which modulate light containing the second light L2 output from the light source apparatus 21, and the projection optical apparatus 6, which projects the light modulated by the light modulators 4R, 4G, and 4B. In the present embodiment, the density Dp of the fluorescence emission points of the phosphor 33 decreases along the direction from the second surface 30b toward the first surface 30a, as described above. Therefore, an increase in the amount of the second light L2 absorbed in the portion of the wavelength converter 30 that is close to the first surface 30a can be suppressed, and the amount of thermal quenching of the second light L2 in the portion close to the first surface 30a can be suppressed, as described above. The wavelength conversion efficiency of the wavelength converter 30 can therefore be increased. The amount of the first light L1 required to cause the wavelength converter 30 to output a predetermined amount of second light L2 toward the angle converting member 38 can thus be reduced. The amount of the first light L1 emitted by the light emitters 36 can therefore be reduced, so that the power consumed by the projector 1 can be suppressed.

### Variation of First Embodiment

A projector 101 according to a variation of the first embodiment will be described below.

The basic configuration of the projector 101 according to the present variation is the same as that of the projector 1 according to the first embodiment, and the projector 101 according to the present variation includes a reflector 142. In the following description, elements having aspects that are the same as those of the projector 1 according to the first embodiment described above have the same reference characters, and will not be described.

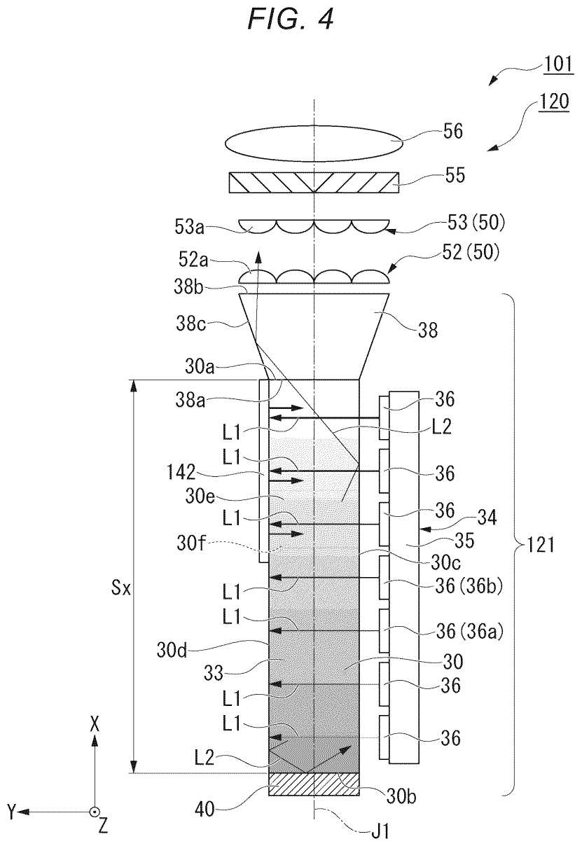

FIG. 4 is a schematic configuration diagram of a first Illuminator 120 in the present variation.

The first illuminator 120 includes a light source apparatus 121, the optical integration system 50, the polarization converter 55, and the superimposing system 56, as shown in FIG. 4. The configuration and other factors of the optical integration system 50, the polarization converter 55, and the superimposing system 56 in the present variation are the same as those of the optical integration system 50, the polarization converter 55, and the superimposing system 56 in the first embodiment described above.

The light source apparatus 121 according to the present variation converts the first light L1 into the yellow second light L2, and outputs the second light L2 toward the optical integration system 50. The light source apparatus 121 includes the wavelength converter 30, the light source section 34, the angle converting member 38, the reflector section 40, and the reflector 142.

The reflector 142 is provided at a portion of the fourth surface 30d of the wavelength converter 30 that is close to the first surface 30a. The reflector 142 reflects the first light L1 having been guided through the interior of the wavelength converter 30 in the light incident direction (Y-axis direction) and having reached the fourth surface 30d. When viewed in the light incident direction, an end portion of the reflector 142 that is close to the first surface 30a overlaps with the first surface 30a. The end portion of the reflector 142 that is close to the first surface 30a may be located at a position shifted from the first surface 30a toward the second surface 30b. An end portion of the reflector 142 that is close to the second surface 30b is located near the center of the fourth surface 30d in the longitudinal direction (X-axis direction). In the present variation, the reflector 142 is configured with a metal film or a dielectric multilayer film formed at the fourth surface 30d. The reflector 142 may instead, for example, be a mirror made of metal. The reflector 142 may be disposed away from the fourth surface 30d in the light incident direction. Other configurations and factors of the light source apparatus 121 according to the present variation are the same as those of the light source apparatus 21 according to the first embodiment described above.

According to the present variation, the reflector 142, which reflects the first light L1, is provided at the portion of the fourth surface 30d that is close to the first surface 30a. The density Dp of the fluorescence emission points in the portion of the wavelength converter 30 that is close to the first surface 30a is low in present variation, as in the first embodiment described above. The first light L1 having entered the wavelength converter 30 via the third surface 30c is therefore unlikely to be absorbed by the phosphor 33 but is likely to reach the fourth surface 30d. Furthermore, the first light L1 is incident on the fourth surface 30d at small angles of incidence, so that the first light L1 is likely to leak out of the wavelength converter 30 via the fourth surface 30d. In the present variation, however, the first light L1 having reached the fourth surface 30d is reflected off the reflector 142 and allowed to return to the interior of the wavelength converter 30. The intensity P1 of the first light L1 guided through the portion of the wavelength converter 30 that is close to the first surface 30a can thus be increased, so that the amount of the second light L2 emitted in the portion close to the first surface 30a can be increased. The wavelength conversion efficiency of the wavelength converter 30 can therefore be more preferably increased.

### Second Embodiment

A projector 201 according to a second embodiment will be described below.

The basic configuration of the projector 201 according to the present embodiment is the same as that of the projector 1 according to the first embodiment, and the projector 201 according to the present embodiment includes a light source section 234. In the following description, elements having aspects that are the same as those of the projector 1 according to the first embodiment described above have the same reference characters, and will not be described.

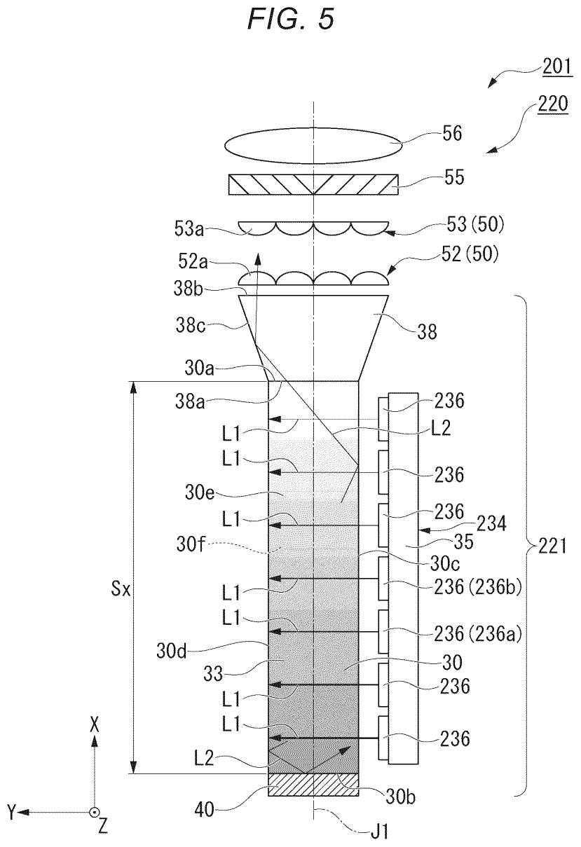

FIG. 5 is a schematic configuration diagram of a first Illuminator 220 in the present embodiment.

The first illuminator 220 includes a light source apparatus 221, the optical integration system 50, the polarization converter 55, and the superimposing system 56, as shown in FIG. 5. The configuration and other factors of the optical integration system 50, the polarization converter 55, and the superimposing system 56 in the present embodiment are the same as those of the optical integration system 50, the polarization converter 55, and the superimposing system 56 in the first embodiment described above.

The light source apparatus 221 according to the present embodiment converts the first light L1 into the yellow second light L2, and outputs the second light L2 toward the optical integration system 50. The light source apparatus 221 includes the wavelength converter 30, the light source section 234, the angle converting member 38, and the reflector section 40.

The light source section 234 outputs the first light L1 toward the wavelength converter 30. The light source section 234 is disposed so as to face the third surface 30c of the wavelength converter 30 in the light incident direction (Y-axis direction). The light source section 234 includes the substrate 35 and a light emitter 236. That is, the light source apparatus 21 includes the light emitter 236.

The light emitter 236 is configured, for example, with a light emitting diode. The light emitter 236 emits the first light L1 having the first wavelength band toward the third surface 30c of the wavelength converter 30. The first light L1 thus enters the wavelength converter 30 via the third surface 30c. The light source section 234 includes multiple light emitters 236. That is, the light source apparatus 221 includes the multiple light emitters 236. In the present embodiment, the light source section 234 includes seven light emitters 236. The light emitters 236 are arranged side by side in the longitudinal direction (X-axis direction). The light emitters 236 each face the third surface 30c in the light incident direction (Y-axis direction). The multiple light emitters 236 include a first light emitter 236a and a second light emitter 236b.

The first light emitter 236a is any one of the multiple light emitters 236. The second light emitter 236b is any one of the multiple light emitters 236 that is disposed closer to the first surface 30a of the wavelength converter 30 than the first light emitter 236a. In the present embodiment, the intensity P1 of the first light L1 emitted by the second light emitter 236b is lower than the intensity P1 of the first light L1 emitted by the first light emitter 236a. Therefore, in the present embodiment, a light emitter 236 disposed closer to the first surface 30a emits less intense first light L1. The intensity P1 of the first light L1 emitted to the third surface 30c thus decreases along the direction from the second surface 30b toward the first surface 30a. The intensity P1 of the first light L1 incident on the third surface 30c therefore decreases along the direction from the second surface 30b toward the first surface 30a. The intensity P1 of the first light L1 that enters the wavelength converter 30 via the third surface 30c thus decreases along the direction from the second surface 30b toward the first surface 30a. Other configurations and factors of the light source apparatus 221 according to the present embodiment are the same as those of the light source apparatus 21 according to the first embodiment described above. Note that the reflector 142 may be provided at a portion of the fourth surface 30d of the wavelength converter 30 that is close to the first surface 30a, as in the variation of the first embodiment described above.

According to the present embodiment, the multiple light emitters 236 each face the third surface 30c and are disposed side by side in the longitudinal direction (X-axis direction), and include the first light emitter 236a and the second light emitter 236b, which is disposed closer to the first surface 30a than the first light emitter 236a, and the intensity P1 of the first light L1 emitted by the second light emitter 236b is lower than the intensity P1 of the first light L1 emitted by the first light emitter 236a. The intensity P1 of the first light L1 guided through the portion of the wavelength converter 30 that is close to the first surface 30a can thus be reduced, so that the amount of the first light L1 absorbed in the portion close to the first surface 30a can be reduced. The amount of the heat generated in the phosphor 33 in the portion close to the first surface 30a can thus be suppressed, so that the situation in which the temperature of the portion close to the first surface 30a becomes too high can be avoided. The thermal quenching of the second light L2 in the portion close to the first surface 30a can therefore be reduced, so that the wavelength conversion efficiency of the wavelength converter 30 can be more preferably increased.

The density Dp of the fluorescence emission points in the portion of the wavelength converter 30 that is close to the second surface 30b is high in present embodiment, as in the first embodiment described above. In the present embodiment, the intensity P1 of the first light L1 guided through the portion of the wavelength converter 30 that is close to the second surface 30b can be increased. The amount of the second light L2 emitted in the portion close to the second surface 30b can thus be increased in the present embodiment. The amount of the second light L2 that exits via the first surface 30a can therefore be more preferably increased, so that the wavelength conversion efficiency of the wavelength converter 30 can be more preferably increased.

### Third Embodiment

A projector 301 according to a third embodiment will be described below.

The basic configuration of the projector 301 according to the present embodiment is the same as that of the projector 1 according to the first embodiment, and the projector 301 according to the present embodiment includes a wavelength converter 330. In the following description, elements having aspects that are the same as those of the projector 1 according to the first embodiment described above have the same reference characters, and will not be described.

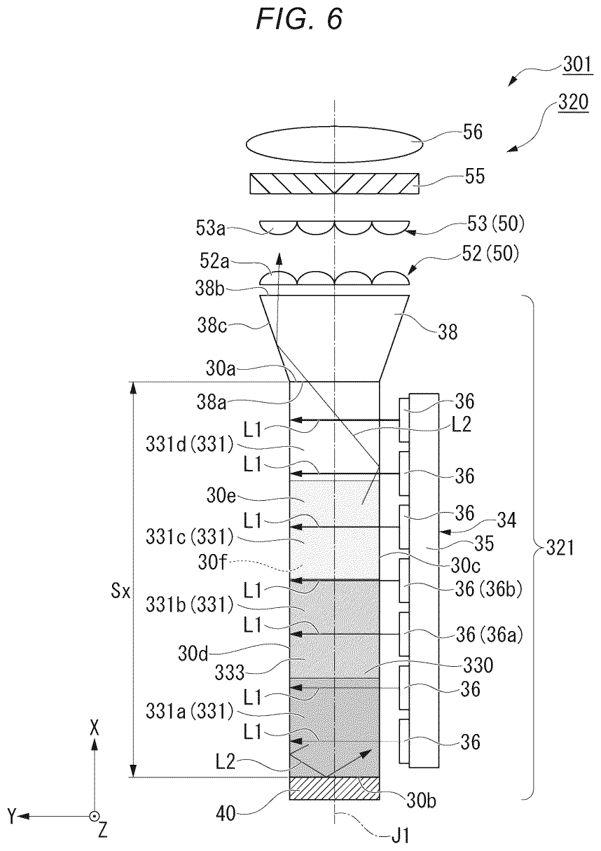

FIG. 6 is a schematic configuration diagram of a first Illuminator 320 in the present embodiment.

The first illuminator 320 includes a light source apparatus 321, the optical integration system 50, the polarization converter 55, and the superimposing system 56, as shown in FIG. 6. The configuration and other factors of the optical integration system 50, the polarization converter 55, and the superimposing system 56 in the present embodiment are the same as those of the optical integration system 50, the polarization converter 55, and the superimposing system 56 in the first embodiment described above.

The light source apparatus 321 according to the present embodiment converts the first light L1 into the yellow second light L2, and outputs the second light L2 toward the optical integration system 50. The light source apparatus 321 includes the wavelength converter 330, the light source section 34, the angle converting member 38, and the reflector section 40. Note that the light source section 34 may be the light source section 234 in the second embodiment described above, in which the intensity of the first light L1 emitted by the second light emitter 236b is lower than the intensity of the first light L1 emitted by the first light emitter 236a.

The wavelength converter 330 converts the first light L1 having the first wavelength band into the second light L2 having the second wavelength band different from the first wavelength band. The wavelength converter 330 has a quadrangular prismatic shape extending in the X-axis direction. The dimension of the wavelength converter 330 in the X-axis direction is greater than each of the dimensions thereof in the Y-axis and Z-axis directions. The wavelength converter 330 has the first surface 30a, the second surface 30b, the third surface 30c, the fourth surface 30d, the fifth surface 30e, and the sixth surface 30f. The first surface 30a, which face one side in the longitudinal direction (X-axis direction), and the second surface 30b, which face the other side in the longitudinal direction (X-axis direction), are located on opposite sides in the longitudinal direction. The first surface 30a causes the second light L2 to exit toward the angle converting member 38. The third surface 30c intersects with both the first surface 30a and the second surface 30b, and the first light L1 is incident on the third surface 30c. In the present embodiment, the third surface 30c is perpendicular to both the first surface 30a and the second surface 30b.

In the present embodiment, the wavelength converter 330 is configured with multiple laminated sections 331 laminated on each other in the longitudinal direction (X-axis direction). The laminated sections 331 each have a substantially cuboidal shape extending in the longitudinal direction. In the present embodiment, the wavelength converter 330 is configured with four laminated sections 331. The four laminated sections 331 include laminated sections 331a, 331b, 331c, and 331d. The four laminated sections 331 or the laminated sections 331a, 331b, 331c, and 331d are sequentially arranged from the side facing the second surface 30b. The laminated sections 331 are fixed to each other via an optical adhesive. The number of the laminated sections 331, which constitute the wavelength converter 330, is not limited to four, and may be three or less or five or more.

In the present embodiment, the first surface 30a is one of the outer surfaces of the laminated section 331d that faces the angle converting member 38 in the longitudinal direction (X-axis direction). The second surface 30b is one of the outer surfaces of the laminated section 331a that faces the side opposite the first surface 30a. The third surface 30c is configured with outer surfaces of the laminated sections 331 that face the light source section 34 in the light incident direction (Y-axis direction). The fourth surface 30d is configured with outer surfaces of the laminated sections 331 that face the side opposite the surfaces that constitute the third surface 30c. The fifth surface 30e is configured with outer surfaces of the laminated sections 331 that face one side in the Z-axis direction. The sixth surface 30f is configured with outer surfaces of the laminated sections 331 that face the other side in the Z-axis direction.

In the present embodiment, the density Dp of the fluorescence emission points contained in the laminated section 331b is lower than the density Dp of the fluorescence emission points contained in the laminated section 331a. The density Dp of the fluorescence emission points contained in the laminated section 331c is lower than the density Dp of the fluorescence emission points contained in the laminated section 331b. The density Dp of the fluorescence emission points contained in the laminated section 331d is lower than the density Dp of the fluorescence emission points contained in the laminated section 331c. The density Dp of the fluorescence emission points contained in each of the multiple laminated sections 331 is lower than the density Dp of the fluorescence emission points contained in another laminated section 331 disposed on the side facing the second surface 30b. The density Dp of the fluorescence emission points in a phosphor 333 of the wavelength converter 330 therefore decreases along the direction from the second surface 30b toward the first surface 30a. In more detail, the density Dp of the fluorescence emission points in the phosphor 333 of the wavelength converter 330 decreases stepwise along the direction from the second surface 30b toward the first surface 30a. The other configurations and other factors of the wavelength converter 330 in the present embodiment are the same as those of the wavelength converter 30 in the first embodiment described above. Note that the reflector 142 may be provided at a portion of the fourth surface 30d of the wavelength converter 330 that is close to the first surface 30a, as in the variation of the first embodiment described above.

According to the present embodiment, the density Dp of the fluorescence emission points of the phosphor 333 of the wavelength converter 330 decreases along the direction from the second surface 30b toward the first surface 30a. Therefore, an increase in the amount of the second light L2 absorbed in the portion of the wavelength converter 330 that is close to the first surface 30a can be suppressed, and the amount of thermal quenching of the second light L2 in the portion close to the first surface 30a can be suppressed, as in the first embodiment described above. The wavelength conversion efficiency of the wavelength converter 330 can therefore be increased.

According to the present embodiment, the wavelength converter 330 is configured with the multiple laminated sections 331 laminated on each other in the longitudinal direction (X-axis direction), and the density Dp of the fluorescence emission points contained in each of the multiple laminated sections 331 is lower than the density Dp of the fluorescence emission points contained in another laminated section 331 disposed on the side facing the second surface 30b. The wavelength converter 330 can therefore be configured with the multiple laminated sections 331, in each of which the density Dp of the fluorescence emission points is known in advance, so that the wavelength converter 330 is likely to have a stable fluorescence emission point density distribution Dp in the longitudinal direction as compared with the case where the wavelength converter 330 is configured as an integrated unit. The density Dp of the fluorescence emission points of the phosphor 333 of the wavelength converter 330 is therefore readily lowered in a stable manner along the direction from the second surface 30b toward the first surface 30a. Therefore, an increase in the amount of the second light L2 absorbed in the portion of the wavelength converter 330 that is close to the first surface 30a can be more preferably suppressed, and the amount of thermal quenching of the second light L2 in the portion close to the first surface 30a can be more preferably suppressed. The wavelength conversion efficiency of the wavelength converter 330 can therefore be more preferably increased.

The embodiments of the present disclosure have been described above, and the technical scope of the present disclosure is not limited to the embodiments described above, and various changes can be made thereto without departing from the intent of the present disclosure. An aspect of the present disclosure can have a configuration that is an appropriate combination of the characteristic portions in the embodiments described above.

The shapes, the numbers, the arrangements, the materials, and other factors of the elements of the light source apparatus and the projector are not limited to those in the embodiments described above and can be changed as appropriate. The aforementioned embodiments have been described with reference to the case where the light source apparatus is incorporated in a projector using liquid crystal panels, and the light source apparatus may be incorporated in a projector using a digital micromirror device as a light modulator. The projector may not include multiple light modulators, and may include only one light modulator. The light source apparatus may be used as a lighting apparatus, a headlight of an automobile, and other apparatuses.

The present disclosure will be summarized below as additional remarks.

### Additional Remark 1

A light source apparatus including: multiple light emitters configured to emit first light having a first wavelength band; a wavelength converter containing a phosphor and configured to convert the first light into second light having a second wavelength band different from the first wavelength band and output the second light; and an angle converting member configured to convert an angular distribution of the second light output from the wavelength converter, in which the wavelength converter has a first surface which faces one side in a longitudinal direction and via which the second light exits toward the angle converting member, a second surface facing a side opposite the first surface, and a third surface which intersects with both the first and second surfaces and on which the first light is incident, and a density of fluorescence emission points of the phosphor decreases along a direction from the second surface toward the first surface.

According to the light source apparatus having the configuration described in Additional remark 1, an increase in the amount of the second light absorbed in a portion of the wavelength converter that is close to the first surface can be suppressed, and the amount of thermal quenching of the second light in the portion close to the first surface can be suppressed. The wavelength conversion efficiency of the wavelength converter can therefore be increased.

### Additional Remark 2

The light source apparatus according to Additional remark 1, in which the multiple light emitters each face the third surface and are disposed side by side in the longitudinal direction, and include a first light emitter and a second light emitter disposed closer to the first surface than the first light emitter, and an intensity of the first light emitted by the second light emitter is higher than the intensity of the first light emitted by the first light emitter.

According to the configuration described above, the intensity of the first light that enters the portion of the wavelength converter that is close to the second surface can be reduced. The amount of the first light absorbed in the portion close to the second surface can thus be reduced, so that the situation in which the temperature of the portion close to the second surface becomes too high can be avoided. The thermal quenching of the second light in the portion of the wavelength converter that is close to the second surface can therefore be suppressed. The wavelength conversion efficiency of the wavelength converter can therefore be more preferably increased.

### Additional Remark 3

The light source apparatus according to Additional remark 1, in which the multiple light emitters each face the third surface and are disposed side by side in the longitudinal direction, and include a first light emitter and a second light emitter disposed closer to the first surface than the first light emitter, and an intensity of the first light emitted by the second light emitter is lower than the intensity of the first light emitted by the first light emitter.

According to the configuration described above, the intensity of the first light guided through the portion of the wavelength converter that is close to the first surface can be reduced, so that the amount of the first light absorbed in the portion close to the first surface can be reduced. The amount of heat generated in the portion close to the first surface can thus be suppressed, so that the situation in which the temperature of the portion close to the first surface becomes too high can be avoided. The thermal quenching of the second light in the portion close to the first surface can therefore be reduced, so that the wavelength conversion efficiency of the wavelength converter can be more preferably increased.

### Additional Remark 4

The light source apparatus according to any one of Additional remarks 1 to 3, in which the wavelength converter has a fourth surface that faces a side opposite the third surface, and a reflector configured to reflect the first light is provided at a portion of the fourth surface that is close to the first surface.

According to the configuration described above, the first light having reached the fourth surface is reflected off the reflector and allowed to return to the interior of the wavelength converter. The intensity of the first light guided through the portion of the wavelength converter that is close to the first surface can thus be increased, so that the amount of the second light emitted in the portion close to the first surface can be increased. The wavelength conversion efficiency of the wavelength converter can therefore be more preferably increased.

### Additional Remark 5

The light source apparatus according to any one of Additional remarks 1 to 4, in which a reflector section configured to reflect the second light is provided at the second surface.

The configuration described above allows the second light traveling toward the second surface to be reflected off the reflector section toward the first surface. Leakage of the second light out of the wavelength converter via the second surface can thus be suppressed, so that the amount of the second light that exits via the first surface can be more preferably increased. The wavelength conversion efficiency of the wavelength converter can therefore be more preferably increased.

### Additional Remark 6

The light source apparatus according to any one of Additional remarks 1 to 5, in which the wavelength converter is configured with multiple laminated sections laminated on each other in the longitudinal direction, and the density of the fluorescence emission points contained in each of the multiple laminated sections is lower than the density of the fluorescence emission points contained in another laminated section disposed on a side facing the second surface.

According to the configuration described above, the wavelength converter can be configured with the multiple laminated sections, in each of which the density of the fluorescence emission points is known in advance, so that the wavelength converter is likely to have a stable fluorescence emission point density distribution in the longitudinal direction. The density of the fluorescence emission points of the phosphor of the wavelength converter is therefore readily lowered in a stable manner along the direction from the second surface toward the first surface. Therefore, an increase in the amount of the second light absorbed in the portion of the wavelength converter that is close to the first surface can be more preferably suppressed, and the amount of thermal quenching of the second light in the portion close to the first surface can be more preferably suppressed. The wavelength conversion efficiency of the wavelength converter can therefore be more preferably increased.

### Additional Remark 7

A projector including: the light source apparatus according to any one of the additional remarks 1 to 6; a light modulator configured to modulate light containing the second light output from the light source apparatus; and a projection optical apparatus configured to project the light modulated by the light modulator.

According to the projector having the configuration described above, the wavelength conversion efficiency of the wavelength converter can be increased, so that the amount of the first light required to cause the wavelength converter to output a predetermined amount of second light can be reduced. The amount of the first light emitted by the light emitters can therefore be reduced, so that the power consumed by the projector can be suppressed.

What is claimed is:

1. A light source apparatus comprising:
multiple light emitters configured to emit first light having a first wavelength band;
a wavelength converter containing a phosphor and configured to convert the first light into second light having a second wavelength band different from the first wavelength band and output the second light; and
an angle converting member configured to convert an angular distribution of the second light output from the wavelength converter,
wherein the wavelength converter has a first surface which faces one side in a longitudinal direction and via which the second light exits toward the angle converting member, a second surface facing a side opposite the first surface, and a third surface which intersects with both the first and second surfaces and on which the first light is incident, and
a density of fluorescence emission points of the phosphor decreases along a direction from the second surface toward the first surface.

2. The light source apparatus according to claim 1, wherein
the multiple light emitters each face the third surface and are disposed side by side in the longitudinal direction, and include a first light emitter and a second light emitter disposed closer to the first surface than the first light emitter, and
an intensity of the first light emitted by the second light emitter is higher than the intensity of the first light emitted by the first light emitter.

3. The light source apparatus according to claim 1, wherein
the multiple light emitters each face the third surface and are disposed side by side in the longitudinal direction, and include a first light emitter and a second light emitter disposed closer to the first surface than the first light emitter, and
an intensity of the first light emitted by the second light emitter is lower than the intensity of the first light emitted by the first light emitter.

4. The light source apparatus according to claim 1, wherein
the wavelength converter has a fourth surface that faces a side opposite the third surface, and
a reflector configured to reflect the first light is provided at a portion of the fourth surface that is close to the first surface.

5. The light source apparatus according to claim 1, wherein
a reflector section configured to reflect the second light is provided at the second surface.

6. The light source apparatus according to claim 1, wherein
the wavelength converter is configured with multiple laminated sections laminated on each other in the longitudinal direction, and
the density of the fluorescence emission points contained in each of the multiple laminated sections is lower than the density of the fluorescence emission points contained in another laminated section disposed on a side facing the second surface.

7. A projector comprising:
the light source apparatus according to claim 1;
a light modulator configured to modulate light containing the second light output from the light source apparatus; and
a projection optical apparatus configured to project the light modulated by the light modulator.
